(19) United States
(12) Patent Application Publication
(10) Pub. No.: US 2023/0315423 A1
(43) Pub. Date: Oct. 5, 2023

(54) HOUSEHOLD APPLIANCES UPDATE MANAGEMENT

(71) Applicant: Haier US Appliance Solutions, Inc., Wilmington, DE (US)

(72) Inventors: Ryan James Scheckelhoff, Louisville, KY (US); Steven Keith Root, Buckner, KY (US)

(21) Appl. No.: 17/711,413

(22) Filed: Apr. 1, 2022

(51) Int. Cl. G06F 8/65; H04L 12/28

(52) U.S. Cl. CPC G06F 8/65; H04L 12/2807; H04L 12/2818; H04L 2012/285; H04L 2012/2841

(57) ABSTRACT

A method of operating a group of household appliances includes connecting, by a primary household appliance of the group of household appliances, to a remote computing device. The method also includes determining, by the remote computing device, that a secondary household appliance of the group of household appliances has an available update and providing, on the primary household appliance, a notification of the available update for the secondary household appliance.

### FIELD OF THE INVENTION

The present subject matter relates generally to household appliances which can connect to a home network and/or a remote network such as the internet. In particular, the present subject matter relates to systems and methods where features, such as connectivity status, update availability, etc., for multiple household appliances may be managed using a user interface of one household appliance.

### BACKGROUND OF THE INVENTION

Household appliances are utilized generally for a variety of tasks by a variety of users. For example, a household may include such appliances as laundry appliances, e.g., a washer and/or dryer, kitchen appliances, e.g., a refrigerator, a microwave, and/or a coffee maker, along with room air conditioners and other various appliances.

Some household appliances can also include features for connecting to and communicating over a secure wireless network. Such communication may provide connected features on the household appliances, e.g., where the household appliance communicates with a personal device, smart home systems, and/or a remote computing device such as a cloud server or database. Such communication may also provide the ability to update the household appliances, such as to provide new or improved features and functionality to the household appliances by downloading updated control software or firmware to the connected household appliance from the cloud.

Such connectable household appliances are not necessarily actually connected to the available networks or systems, such as the cloud. For example, some users may find the provisioning, e.g., initial connection and setup, process for such household appliances to be burdensome or tedious, resulting in a connectable household appliance not being actually connected. As another example, one or more network settings may change after a household appliance is connected, such as a network name, e.g., SSID, etc., for a residential wireless network through which the household appliance connects to the internet, resulting in a previously connected household appliance becoming unconnected. Some such household appliances may be connectable, and may even be in fact connected, but may lack features for easily informing a user of an available update. For example, the household appliance may only include a limited or low-end user interface, such as a seven-segment display, which makes providing detailed information, such as update status, inconvenient on the user interface of the household appliance.

Accordingly, there exists a need for systems and methods which permit identifying available updates for household appliances and informing a user of the same in an easier and more convenient manner.

### BRIEF DESCRIPTION OF THE INVENTION

Aspects and advantages of the invention will be set forth in part in the following description, or may be obvious from the description, or may be learned through practice of the invention.

In accordance with one exemplary embodiment of the present disclosure, a method of operating a group of household appliances is provided. The method includes connecting, by a primary household appliance of the group of household appliances, to a remote computing device. The method also includes generating a manifest of the group of appliances. The method further includes determining that a secondary household appliance of the group of household appliances has an available update and providing, on the primary household appliance, a notification of the available update for the secondary household appliance.

In accordance with another exemplary embodiment of the present disclosure, a method of operating a group of household appliances is provided. The method includes connecting, by a primary household appliance of the group of household appliances, to a remote computing device. The method also includes determining, by the remote computing device, that a secondary household appliance of the group of household appliances has an available update and providing, on the primary household appliance, a notification of the available update for the secondary household appliance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of exemplary laundry appliances in accordance with one or more exemplary embodiments of the present disclosure.

FIG. 2 provides a side cross-sectional view of one of the exemplary laundry appliances of FIG. 1.

FIG. 3 provides a perspective view of the other exemplary laundry appliance of FIG. 1 with portions of a cabinet of the laundry appliance removed to reveal certain components of the laundry appliance.

FIG. 4 provides a front view of an exemplary group of kitchen appliances in accordance with one or more additional exemplary embodiments of the present disclosure.

FIG. 5 provides a side schematic view of the group of kitchen appliances of FIG. 4.

FIG. 6 provides a diagrammatic illustration of a primary household appliance and multiple additional household appliances in accordance with one or more additional exemplary embodiments of the present disclosure.

FIG. 7 provides a flowchart illustrating an example method of operating a group of household appliances according to one or more example embodiments of the present disclosure.

FIG. 8 provides a flowchart illustrating another example method of operating a group of household appliances according to one or more example embodiments of the present disclosure.

FIG. 9 provides a flowchart illustrating still another example method of operating a group of household appliances according to one or more example embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise. As used herein, numerical terms such as “first,” “second,” “third,” “primary,” “secondary,” “tertiary,” etc., may be used interchangeably to distinguish one component from another and are not intended to signify location or importance of the individual components.

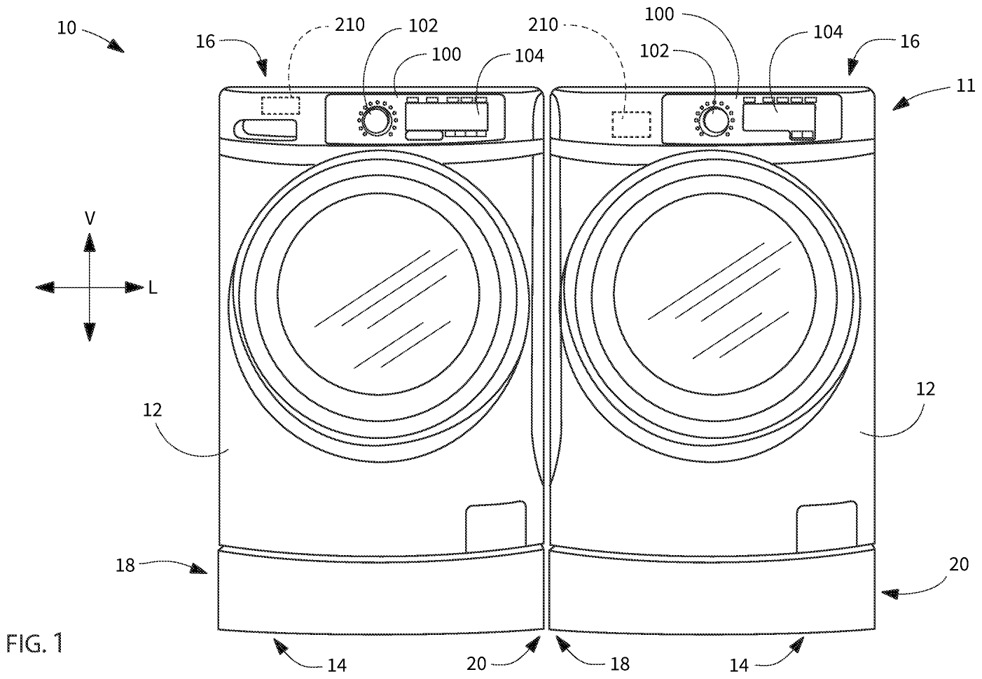

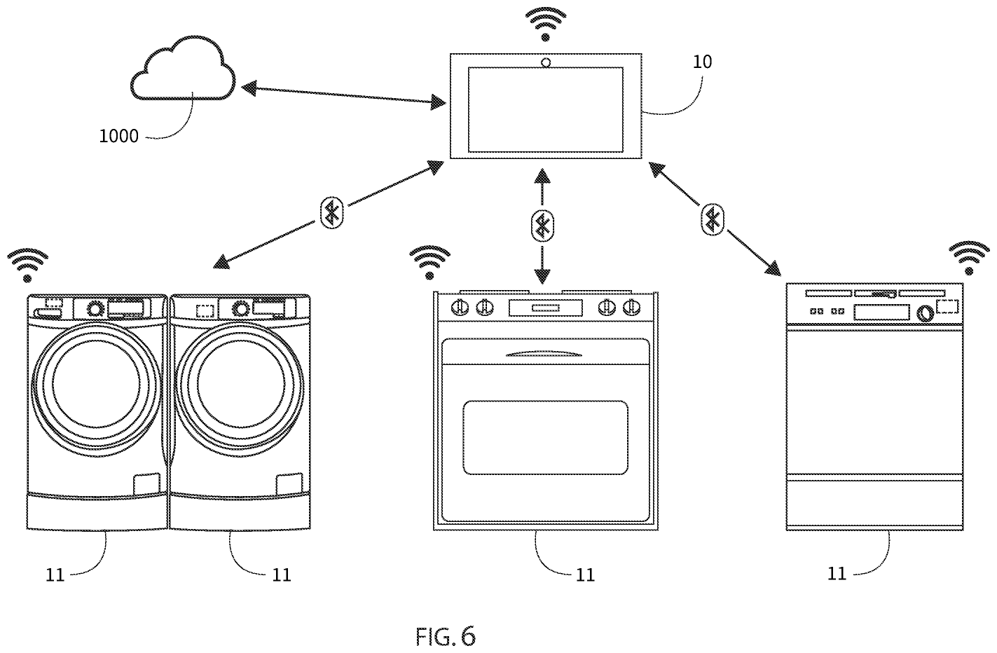

As may be seen in FIGS. 1 through 5, in accordance with one or more embodiments of the present subject matter, a group of household appliances including at least a primary household appliance 10 and a household secondary appliance 11 is provided. The illustrated groups of two appliances are provided by way of example only. Various embodiments of the present subject matter may also include three or more appliances (see, for example, FIG. 6). For example, the exemplary appliances of FIGS. 1 through 5 may each be provided in various combinations with one or more of the other appliances of FIGS. 1 through 5 and/or either or both groups of appliances illustrated in FIGS. 1 through 5. Each appliance of the group or two or more appliances disclosed herein may be operable and configured to connect to one or more remote computing devices, e.g., a cloud or other distributed computing environment, as will be described in more detail below.

As generally seen throughout FIGS. 1 through 5, each appliance 10 and 11 includes a cabinet 12 which defines a vertical direction V and a lateral direction L that are mutually perpendicular. Each cabinet 12 extends between a top side 16 and a bottom side 14 along the vertical direction V. Each cabinet 12 also extends between a left side 18 and a right side 20, e.g., along the lateral direction L.

Each appliance 10 and 11 may include a user interface panel 100 and a user input device 102 which may be positioned on an exterior of the cabinet 12. The user input device 102 is generally positioned proximate to the user interface panel 100, and in some embodiments, the user input device 102 may be positioned on the user interface panel 100.

In various embodiments, the user interface panel 100 may represent a general purpose I/O (“GPIO”) device or functional block. In some embodiments, the user interface panel 100 may include or be in operative communication with user input device 102, such as one or more of a variety of digital, analog, electrical, mechanical or electro-mechanical input devices including rotary dials, control knobs, push buttons, and touch pads. The user interface panel 100 may include a display component 104, such as a digital or analog display device designed to provide operational feedback to a user. The display component 104 may also be a touchscreen capable of receiving a user input, such that the display component 104 may also be the user input device 102.

Generally, each appliance 10 and 11 may include a controller 210 in operative communication with the user input device 102. The user interface panel 100 and the user input device 102 may be in communication with the controller 210 via, for example, one or more signal lines or shared communication busses. Input/output (“I/O”) signals may be routed between controller 210 and various operational components of the appliances 10 and 11. Operation of the appliances 10 and 11 may each be regulated by the respective controller 210 that is operatively coupled to the corresponding user interface panel 100. A user interface panel 100 may for example provide selections for user manipulation of the operation of an appliance, e.g., via user input device 102 and/or display 104. In response to user manipulation of the user interface panel 100 and/or user input device 102, the controller 210 may operate various components of the appliance 10 or 11. Each controller 210 may include a memory and one or more microprocessors, CPUs or the like, such as general or special purpose microprocessors operable to execute programming instructions or micro-control code associated with operation of the appliance 10 or 11. The memory may represent random access memory such as DRAM, or read only memory such as ROM or FLASH. In one embodiment, the processor executes programming instructions stored in memory. The memory may be a separate component from the processor or may be included onboard within the processor. Alternatively, a controller 210 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

The controller 210 may be programmed to operate the respective appliance 10 or 11 by executing instructions stored in memory. For example, the instructions may be software or any set of instructions that when executed by the processing device, cause the processing device to perform operations. Controller 210 can include one or more processor(s) and associated memory device(s) configured to perform a variety of computer-implemented functions and/or instructions (e.g. performing the methods, steps, calculations and the like and storing relevant data as disclosed herein). It should be noted that controllers 210 as disclosed herein are capable of and may be operable to perform any methods and associated method steps as disclosed herein.

In some embodiments, for example, as illustrated in FIG. 1, the group of household appliances 10 and 11 may be or include a pair of laundry appliances. In the exemplary embodiment illustrated in FIG. 1, the primary appliance may be a washing machine appliance 10 and the secondary appliance may be a clothes dryer 11. In other embodiments, the washing machine appliance may be the secondary appliance and the clothes dryer may be the primary appliance. In embodiments such as illustrated in FIG. 1, the user input device 102 of each household appliance 10 and 11 may be positioned on the user interface panel 100. The embodiment illustrated in FIG. 1 also includes a display 104 on the user interface panel 100 of each household appliance 10 and 11. The display 104 of either laundry appliance 10 or 11 may be a high-end user interface or a component of a high-end user interface, in accordance with the meaning of “high-end” user interface described in more detail below.

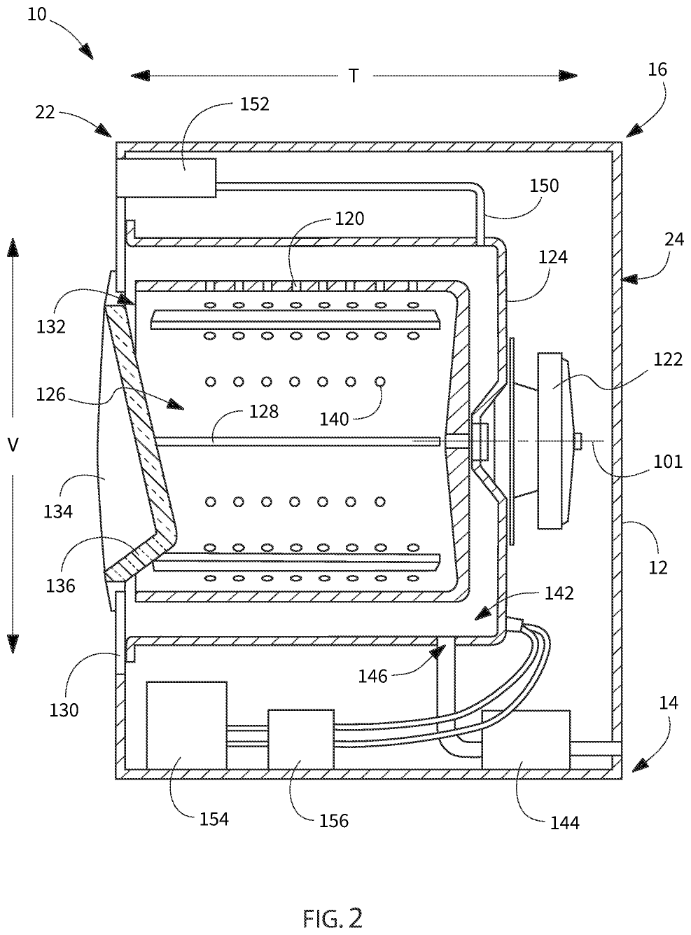

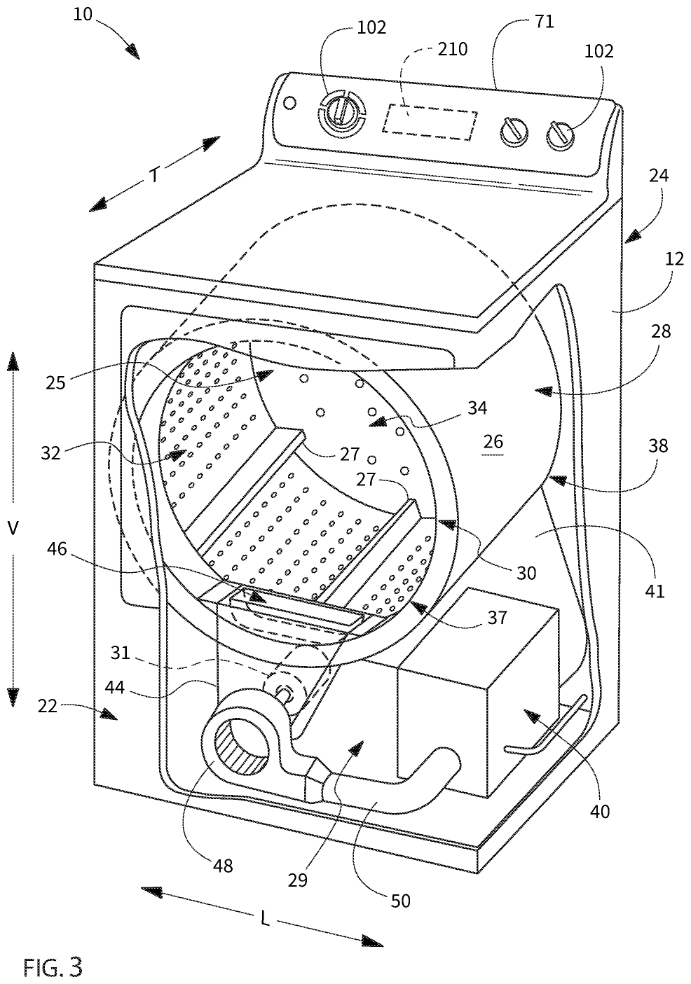

Additional exemplary details of the laundry appliances 10 and 11 are illustrated in FIGS. 2 and 3. For example, FIG. 2 provides a cross-sectional view of an exemplary washing machine appliance 10 which may, in various embodiments, be one appliance of a group of connected appliances. As illustrated in FIG. 2, a wash tub 124 is non-rotatably mounted within cabinet 12. As may be seen in FIG. 2, the wash tub 124 defines a central axis 101. In the example embodiment illustrated by FIG. 2, the central axis 101 may be oriented generally along or parallel to the transverse direction T of the washing machine appliance 10. Accordingly, the washing machine appliance 10 may be referred to as a horizontal axis washing machine.

Referring again to FIG. 2, a wash basket 120 is rotatably mounted within the tub 124 such that the wash basket 120 is rotatable about an axis of rotation, which generally coincides with central axis 101 of the tub 124. A motor 122, e.g., such as a pancake motor, is in mechanical communication with wash basket 120 to selectively rotate wash basket 120 (e.g., during an agitation or a rinse cycle of washing machine appliance 10). Wash basket 120 defines a wash chamber 126 that is configured for receipt of articles for washing. The wash tub 124 holds wash and rinse fluids for agitation in wash basket 120 within wash tub 124. As used herein, “wash fluid” may refer to water, detergent, fabric softener, bleach, or any other suitable wash additive or combination thereof. The wash basket 120 and the tub 124 may collectively define at least a portion of a tub assembly for the washing machine appliance 10.

Wash basket 120 may define one or more agitator features that extend into wash chamber 126 to assist in agitation and cleaning of articles disposed within wash chamber 126 during operation of washing machine appliance 10. For example, as illustrated in FIG. 2, a plurality of ribs 128 extends from basket 120 into wash chamber 126. In this manner, for example, ribs 128 may lift articles disposed in wash basket 120 during rotation of wash basket 120.

Referring generally to FIGS. 1 and 2, cabinet 12 also includes a front panel 130 which defines an opening 132 that permits user access to wash basket 120 within wash tub 124. More specifically, washing machine appliance 10 includes a door 134 that is positioned in front of opening 132 and is rotatably mounted to front panel 130. Door 134 is rotatable such that door 134 permits selective access to opening 132 by rotating between an open position (not shown) facilitating access to a wash tub 124 and a closed position (FIG. 1) prohibiting access to wash tub 124.

A window 136 in door 134 permits viewing of wash basket 120 when door 134 is in the closed position, e.g., during operation of washing machine appliance 10. Door 134 also includes a handle (not shown) that, e.g., a user may pull when opening and closing door 134. Further, although door 134 is illustrated as mounted to front panel 130, it should be appreciated that door 134 may be mounted to another side of cabinet 12 or any other suitable support according to alternative embodiments.

Referring again to FIG. 2, wash basket 120 also defines a plurality of perforations 140 in order to facilitate fluid communication between an interior of basket 120 and wash tub 124. A sump 142 is defined by wash tub 124 at a bottom of wash tub 124 along the vertical direction V. Thus, sump 142 is configured for receipt of and generally collects wash fluid during operation of washing machine appliance 10. For example, during operation of washing machine appliance 10, wash fluid may be urged by gravity from basket 120 to sump 142 through plurality of perforations 140. A pump assembly 144 is located beneath tub 124 for gravity assisted flow when draining tub 124, e.g., via a drain 146. Pump assembly 144 may be configured for recirculating wash fluid within wash tub 124.

A spout 150 is configured for directing a flow of fluid into wash tub 124. For example, spout 150 may be in fluid communication with a water supply (not shown) in order to direct fluid (e.g., clean water) into wash tub 124. Spout 150 may also be in fluid communication with the sump 142. For example, pump assembly 144 may direct wash fluid disposed in sump 142 to spout 150 in order to circulate wash fluid in wash tub 124.

As illustrated in FIG. 2, a detergent drawer 152 is slidably mounted within front panel 130. Detergent drawer 152 receives a wash additive (e.g., detergent, fabric softener, bleach, or any other suitable liquid or powder) and directs the fluid additive to wash chamber 124 during operation of washing machine appliance 10. According to the illustrated embodiment, detergent drawer 152 may also be fluidly coupled to spout 150 to facilitate the complete and accurate dispensing of wash additive.

Additionally, a bulk reservoir 154 is disposed within cabinet 12. Bulk reservoir 154 is also configured for receipt of fluid additive for use during operation of washing machine appliance 10. Bulk reservoir 154 is sized such that a volume of fluid additive sufficient for a plurality or multitude of wash cycles of washing machine appliance 10 (e.g., five, ten, twenty, fifty, or any other suitable number of wash cycles) may fill bulk reservoir 154. Thus, for example, a user can fill bulk reservoir 154 with fluid additive and operate washing machine appliance 10 for a plurality of wash cycles without refilling bulk reservoir 154 with fluid additive. A reservoir pump 156 is configured for selective delivery of the fluid additive from bulk reservoir 154 to wash tub 124.

During operation of washing machine appliance 10, laundry items are loaded into wash basket 120 through opening 132, and washing operation is initiated through operator manipulation of input selectors 102. Wash tub 124 is filled with water, detergent, and/or other fluid additives, e.g., via spout 150 and/or detergent drawer 152. One or more valves (not shown) can be controlled by washing machine appliance 10 to provide for filling wash basket 120 to the appropriate level for the amount of articles being washed and/or rinsed. By way of example for a wash mode, once wash basket 120 is properly filled with fluid, the contents of wash basket 120 can be agitated (e.g., with ribs 128) for washing of laundry items in wash basket 120.

After the agitation phase of the wash cycle is completed, wash tub 124 can be drained. Laundry articles can then be rinsed by again adding fluid to wash tub 124, depending on the particulars of the cleaning cycle selected by a user. Ribs 128 may again provide agitation within wash basket 120. One or more spin cycles may also be used. In particular, a spin cycle may be applied after the wash cycle and/or after the rinse cycle in order to wring wash fluid from the articles being washed. During a spin cycle, basket 120 is rotated at relatively high speeds. After articles disposed in wash basket 120 are cleaned and/or washed, the user can remove the articles from wash basket 120, e.g., by opening door 134 and reaching into wash basket 120 through opening 132.

While described in the context of a specific embodiment of horizontal axis washing machine appliance 10, using the teachings disclosed herein it will be understood that horizontal axis washing machine appliance 10 is provided by way of example only. Other washing machine appliances having different configurations, different appearances, and/or different features may also be utilized with the present subject matter as well, e.g., vertical axis washing machine appliances.

FIG. 3 provides a perspective view of the dryer appliance 11 of FIG. 1 with a portion of a cabinet or housing 12 of dryer appliance 11 removed in order to show certain components of dryer appliance 10. Dryer appliance 11 generally defines a vertical direction V, a lateral direction L, and a transverse direction T, each of which is mutually perpendicular, such that an orthogonal coordinate system is defined. While described in the context of a specific embodiment of dryer appliance 11, using the teachings disclosed herein, it will be understood that dryer appliance 11 is provided by way of example only. Other dryer appliances having different appearances and different features may also be utilized with the present subject matter as well.

Cabinet 12 includes a front side 22 and a rear side 24 spaced apart from each other along the transverse direction T. Within cabinet 12, an interior volume 29 is defined. A drum or container 26 is mounted for rotation about a substantially horizontal axis within the interior volume 29. Drum 26 defines a chamber 25 for receipt of articles of clothing for tumbling and/or drying. Drum 26 extends between a front portion 37 and a back portion 38. Drum 26 also includes a back or rear wall 34, e.g., at back portion 38 of drum 26. A supply duct 41 may be mounted to rear wall 34 and receives heated air that has been heated by a heating assembly or system 40.

As used herein, the terms “clothing” or “articles” includes but need not be limited to fabrics, textiles, garments, linens, papers, or other items from which the extraction of moisture is desirable. Furthermore, the term “load” or “laundry load” refers to the combination of clothing that may be washed together in a washing machine or dried together in a dryer appliance 11 (e.g., clothes dryer) and may include a mixture of different or similar articles of clothing of different or similar types and kinds of fabrics, textiles, garments and linens within a particular laundering process.

A motor 31 is provided in some embodiments to rotate drum 26 about the horizontal axis, e.g., via a pulley and a belt (not pictured). Drum 26 is generally cylindrical in shape, having an outer cylindrical wall 28 and a front flange or wall 30 that defines an opening 32 of drum 26, e.g., at front portion 37 of drum 26, for loading and unloading of articles into and out of chamber 25 of drum 26. A plurality of lifters or baffles 27 are provided within chamber 25 of drum 26 to lift articles therein and then allow such articles to tumble back to a bottom of drum 26 as drum 26 rotates. Baffles 27 may be mounted to drum 26 such that baffles 27 rotate with drum 26 during operation of dryer appliance 10.

The rear wall 34 of drum 26 may be rotatably supported within the cabinet 12 by a suitable fixed bearing. Rear wall 34 can be fixed or can be rotatable. Rear wall 34 may include, for instance, a plurality of holes that receive hot air that has been heated by heating system 40. The heating system 40 may include, e.g., a heat pump, an electric heating element, and/or a gas heating element (e.g., gas burner). Moisture laden, heated air is drawn from drum 26 by an air handler, such as blower fan 48, which generates a negative air pressure within drum 26. The moisture laden heated air passes through a duct 44 enclosing screen filter 46, which traps lint particles. As the air passes from blower fan 48, it enters a duct 50 and then is passed into heating system 40. In some embodiments, the dryer appliance 10 may be a conventional dryer appliance, e.g., the heating system 40 may be or include an electric heating element, e.g., a resistive heating element, or a gas-powered heating element, e.g., a gas burner. In other embodiments, the dryer appliance may be a condensation dryer, such as a heat pump dryer. In such embodiments, heating system 40 may be or include a heat pump including a sealed refrigerant circuit. Heated air (with a lower moisture content than was received from drum 26), exits heating system 40 and returns to drum 26 by duct 41. After the clothing articles have been dried, they are removed from the drum 26 via opening 32. A door (FIG. 1) provides for closing or accessing drum 26 through opening 32.

In some embodiments, one or more selector inputs 102, such as knobs, buttons, touchscreen interfaces, etc., may be provided or mounted on a cabinet 12 (e.g., on a backsplash 71) and are in operable communication (e.g., electrically coupled or coupled through a wireless network band) with the processing device or controller 210. Controller 210 may also be provided in operable communication with components of the dryer appliance 11 including motor 31, blower 48, or heating system 40. In turn, signals generated in controller 210 direct operation of motor 31, blower 48, or heating system 40 in response to the position of inputs 102. As used herein, “processing device” or “controller” may refer to one or more microprocessors, microcontroller, ASICS, or semiconductor devices and is not restricted necessarily to a single element. The controller 210 may be programmed to operate dryer appliance 10 by executing instructions stored in memory (e.g., non-transitory media). The controller 56 may include, or be associated with, one or more memory elements such as RAM, ROM, or electrically erasable, programmable read only memory (EEPROM). For example, the instructions may be software or any set of instructions that when executed by the processing device, cause the processing device to perform operations. It should be noted that controllers as disclosed herein are capable of and may be operable to perform any methods and associated method steps as disclosed herein. For example, in some embodiments, methods disclosed herein may be embodied in programming instructions stored in the memory and executed by the controller.

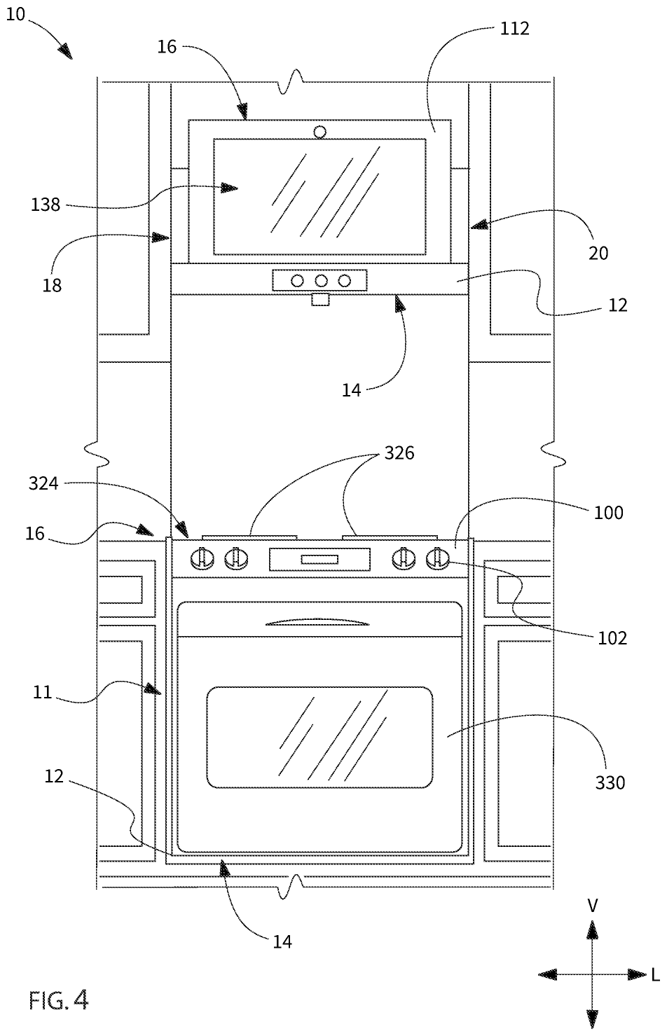

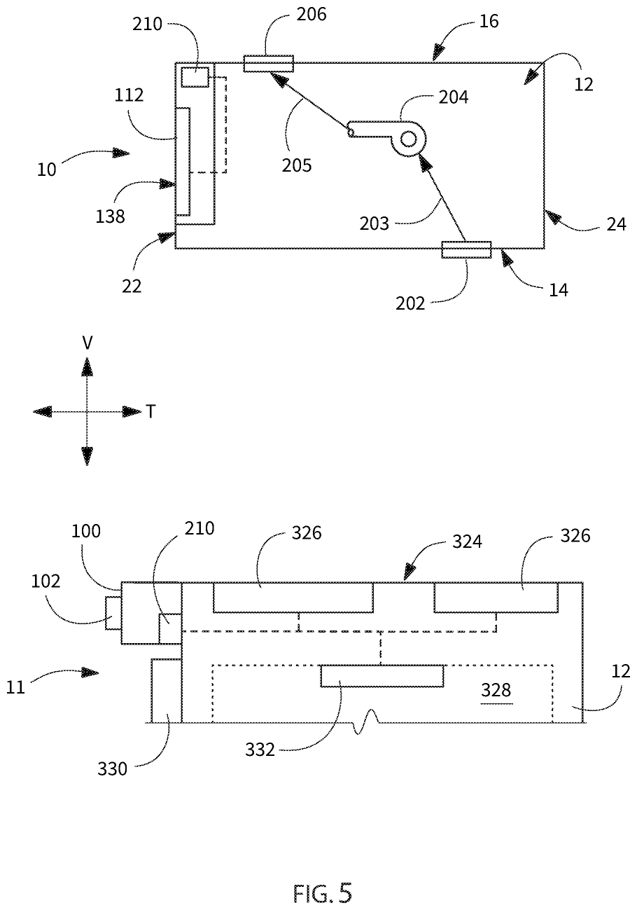

FIGS. 4 and 5 illustrate another example embodiment of a group of household appliances where the primary appliance 10 and the secondary appliance 11 are kitchen appliances. In the particular exemplary embodiment illustrated in FIGS. 4 and 5, the primary appliance 10 is a user engagement system which includes an image monitor 112 that is generally positioned above a cooktop appliance 11, e.g., along the vertical direction V. Image monitor 112 may include a touchscreen capable of receiving a user input by detecting and responding to a touch on a surface of the image monitor 112.

Referring again to FIGS. 4 and 5, cooktop appliance 11 includes a chassis or cabinet 12 that extends along the vertical direction V between a top side 16 and a bottom side 14. Cooktop appliance 11 can include a cooktop surface 324 having one or more heating elements 326 for use in, for example, heating or cooking operations. In one example embodiment, cooktop surface 324 is constructed with ceramic glass. In other embodiments, however, cooktop surface 324 may include any another suitable material, such as a metallic material (e.g., steel) or another suitable non-metallic material. Heating elements 326 may be various sizes and may employ any suitable method for heating or cooking an object, such as a cooking utensil (not shown), and its contents. In one embodiment, for example, heating element 326 uses a heat transfer method, such as electric coils or gas burners, to heat the cooking utensil. In another embodiment, however, heating element 326 uses an induction heating method to heat the cooking utensil directly. In various embodiments, the heating elements 326 may include one or more of a gas burner element, resistive heat element, radiant heat element, induction element, or another suitable heating element.

In some embodiments, the cabinet 12 of the cooktop appliance 11 may be insulated and may define a cooking chamber 328 selectively enclosed by a door 330. One or more heating elements 332 (e.g., top broiling elements or bottom baking elements) may be positioned within cabinet 12 of cooktop appliance 11 to heat cooking chamber 328. Heating elements 332 within cooking chamber 328 may be provided as any suitable element for cooking the contents of cooking chamber 328, such as an electric resistive heating element, a gas burner, a microwave element, a halogen element, etc. Thus, cooktop appliance 11 may be referred to as an oven range appliance. As will be understood by those skilled in the art, cooktop appliance 11 is provided by way of example only, and the present subject matter may be used in the context of any suitable cooking appliance, such as a double oven range appliance or a standalone cooktop (e.g., fitted integrally with a surface of a kitchen counter). Thus, the example embodiments illustrated and described are not intended to limit the present subject matter to any particular cooking chamber or heating element configuration, unless explicitly indicated as being limited.

As illustrated, a user interface panel 100 may be provided on cooktop appliance 11. Although shown at front portion of cooktop appliance 11, another suitable location or structure (e.g., a backsplash) for supporting user interface panel 100 may be provided in alternative embodiments. In some embodiments, user interface panel 100 includes input components or controls 102, such as one or more of a variety of electrical, mechanical, or electro-mechanical input devices. Controls 102 may include, for example, rotary dials, knobs, push buttons, and touch pads. A controller 210 is in communication with user interface panel 100 and controls 102 through which a user may select various operational features and modes and monitor progress of cooktop appliance 11. In additional or alternative embodiments, user interface panel 100 includes a display component, such as a digital or analog display in communication with a controller 210 and configured to provide operational feedback to a user. In certain embodiments, user interface panel 100 represents a general purpose I/O (“GPIO”) device or functional block.

As shown, controller 210 is communicatively coupled (i.e., in operative communication) with user interface panel 100 and its controls 102. Controller 210 may also be communicatively coupled with various operational components of cooktop appliance 300 as well, such as heating elements (e.g., 326, 332), sensors, and the like. Input/output (“I/O”) signals may be routed between controller 210 and the various operational components of cooktop appliance 11. Thus, controller 210 can selectively activate and operate these various components. Various components of cooktop appliance 11 are communicatively coupled with controller 210 via one or more communication lines such as, for example, conductive signal lines, shared communication busses, or wireless communications bands.

As shown in FIGS. 4 and 5, the primary appliance 10 is, by way of example, a user engagement system, which is an example embodiment of a household appliance and which may be one of, such as the primary household appliance, of a group of household appliances. In such embodiments, the primary household appliance 10 may include one or more casings (e.g., a hood casing) provided above cooktop appliance 11 along the vertical direction V. For example, a hood casing 12 may be positioned above cooktop appliance 11. Hood casing 12 includes a plurality of outer walls and generally extends along the vertical direction V between a top side 16 and a bottom side 14, along the lateral direction L between a right side 18 and a left side 20, e.g., “right” and “left” as used herein refer to from a perspective of a user standing in front of the appliance 10. As shown in FIG. 5, the hood casing 12 may also extend along the transverse direction T between a front end 22 and a back end 24. In some embodiments, hood casing 12 is spaced apart from cooktop surface 324 along the vertical direction V such that an open region is defined therebetween.

As shown in FIG. 5, in kitchen appliance embodiments, one of the group of appliances 10 and 11 may be or include a ventilation assembly within hood casing 12 which is configured to direct an airflow from the open region between the appliances 10 and 11 and through hood casing 12 of the upper appliance, e.g., which is indicated as primary appliance 10 in the example illustrations of FIGS. 4 and 5, but which may instead be the secondary appliance 11, e.g., when the cooktop appliance is the primary appliance 10. Other configurations may be used within the spirit and scope of the present disclosure. For example, although a generally rectangular shape is illustrated, any suitable shape or style may be adapted to form the structure of hood casing 12.

In some embodiments, an image monitor 112 may be provided above cooktop surface 324 (e.g., along the vertical direction V). For instance, image monitor 112 may be mounted to or supported on hood casing 12 of the primary appliance 10 (e.g., directly above cooktop surface 324) proximal to the front side 22. Generally, image monitor 112 may be any suitable type of mechanism for visually presenting a digital (e.g., interactive) image. For example, image monitor 112 may be a liquid crystal display (LCD), a plasma display panel (PDP), a cathode ray tube (CRT) display, etc. Thus, image monitor 112 includes an imaging surface 138 (e.g., screen or display panel) at which the digital image is presented or displayed as an optically-viewable picture (e.g., static image or dynamic video) to a user. Optionally, a protective transparent panel (e.g., formed from a transparent glass, plastic, etc.) may be positioned across or over imaging surface 138. In some such embodiments, the protective transparent panel is mounted within or supported on hood casing 12 forward from imaging surface 138 along the transverse direction T.

As an example, image monitor 112 may present recipe information in the form of viewable text or images. As another example, image monitor 112 may present a remotely captured image, such as a live (e.g., real-time) dynamic video stream received from a separate user or device. As yet another example, image monitor 112 may present a graphical user interface (GUI) that allows a user to select or manipulate various operational features of the primary appliance 10 or cooktop appliance 11. During use of such GUI embodiments, a user may engage, select, or adjust the image presented at image monitor 112 through any suitable input, such as gesture controls detected through a camera assembly, voice controls detected through one or more microphones, associated touch panels (e.g., capacitance or resistance touch panel), sensors overlaid across imaging surface 138, or any other suitable input.

As illustrated, the imaging surface 138 is directed toward the area forward from the cooktop appliance 11. During use, a user standing in front of cooktop appliance 11 may thus see the optically-viewable picture (e.g., recipe, dynamic video stream, graphical user interface, etc.) displayed at the imaging surface 138.

As mentioned, in embodiments where the primary appliance 10 is the user engagement system, the primary appliance may be or include a ventilation assembly. In such embodiments, one or more air outlets 206 may be defined by hood casing 12 (e.g., through one or more external walls of hood casing 12). As shown for example in FIG. 5, air outlet 206 defined through hood casing 12 may be defined through hood casing 12 at the top side 16. The ventilation system may generally extend between one or more air inlets 202 defined in the bottom side 14 of the casing 12 and air outlet 206. For example, the bottom side 14 of the casing 12 of the primary appliance 10 may face the cooktop surface 324 of the cooktop appliance 11. The ventilation system may also include an air handler 204 fixedly mounted within the casing 12 in fluid communication with the air inlet 202 to motivate an intake flow of air 203 through the inlet 202 to the air handler 204 and an exhaust flow of air 205 from the air handler 204 to the outlet 206.

As will be understood, air handler 204 may be provided as any suitable blower or fan (e.g., radial fan, tangential fan, etc.) positioned within hood casing 12 to actively rotate or motivate air, steam, or vapors 203 into and through air inlet 202. Optionally, one or more filters (not pictured) may be provided at inlet 202 to clean the air, steam, or vapors 203 as it enters hood casing 12 from the open region between the primary and secondary appliances 10 and 11. For instance, a grease filter having a suitable coarse filter medium, such as a metallic mesh including aluminum or stainless steel, may be mounted across inlet 202. Additionally or alternatively, an odor filter having a suitable fine filter medium, such as a mesh or block including activated carbon, may be mounted across inlet 202. Optionally, the odor filter may be positioned above or downstream from the grease filter.

According to various embodiments of the present disclosure, the group of household appliances 10 and 11 may take the form of any of the examples described above in various combinations of any two or more of the exemplary household appliances described above, or may be any other household appliance. Thus, it will be understood that the present subject matter is not limited to any particular household appliance.

Further, the group of appliances need not necessarily be related or located in the same room as one another. For instance, while the primary and secondary appliances 10 and 11 are both laundry appliances in the example illustrated in FIG. 1 and are both kitchen appliances in the example illustrated in FIG. 4, the group of appliances can include any two or more appliances which are within communication range, e.g., within WI-FI® and/or BLUETOOTH® range, of each other. Thus, in just one possible example, the primary appliance 10 could be a refrigerator appliance, and the secondary appliance 11 could be any of the other example appliances described herein, such as the washer and/or dryer of FIG. 1, as well as any one or more other household appliance or appliances.

It should be understood that “household appliances” and/or “appliances” are used herein to describe appliances typically used or intended for common domestic tasks, such as laundry appliances or kitchen appliances, e.g., as illustrated in FIGS. 1 through 5, or air conditioners, dishwashing appliances, water heaters, etc., and any other household appliance which performs similar functions in addition to network communication and data processing. Thus, devices such as a personal computer, router, and other similar devices whose primary functions are network communication and/or data processing are not considered household appliances as used herein.

As used herein, the term “household” or “residence” includes a domestic structure or dwelling place in which one or more people eat, sleep, and/or spend leisure time. For example, a household (e.g., within which the group of household appliances is located and used) may be a dormitory, condo unit, apartment unit, townhome, single-family home, or other similar places.

Turning now to FIG. 6, an exemplary group of household appliances including a first or primary household appliance 10 and multiple additional household appliances 11, e.g., multiple second or secondary household appliances 11. In particular, the primary household appliance includes a high-end user interface and is connected to one or more remote computing devices, e.g., a remote server, remote database, and/or one or more other such computing devices, e.g., in the cloud 1000. The terms “second household appliance” and “secondary household appliance” are used herein as including one or more household appliances, such as a second group of household appliances or multiple secondary household appliances, e.g., for which status information, such as connection status, firmware version status, etc., may be relayed via the first or primary household appliance 10.

As used herein, a “high-end user interface” includes any user interface which is context-sensitive and which is capable of displaying a comprehensible message, such as multiple lines of text displayed simultaneously. A high-end user interface may be or include, but is not necessarily, an interactive display, such as a touchscreen display. A context-sensitive display with one or more soft keys associated with the display may also be considered a high-end user interface even without the ability to receive input directly on the display, e.g., when the display is not a touchscreen. By contrast, a low-end user interface may be a user interface which only includes or is limited to fixed inputs (in contrast to, e.g., context-sensitive soft keys), one or more seven-segment displays, and/or indicator lights (where such indicator lights, e.g., LED indicators, are recognized by those of ordinary skill in the art as only providing binary information, e.g., ON/OFF status indicators only).

While the primary household appliance 10 is connected, e.g., to the cloud 1000 as illustrated in FIG. 6, the secondary household appliances 11 are connectable, but not necessarily actually connected, household appliances, e.g., the secondary household appliances 11 are capable of connecting to the cloud 1000.

FIG. 6 schematically illustrates a primary household appliance 10 in communication, e.g., wireless communication as illustrated in FIG. 6, with one or more remote computing devices in a distributed computing environment, such as a cloud 1000. For example, the primary household appliance 10, and in particular the controller 210 thereof, may be in communication with one or more remote computing devices, such as remote computers, servers, and/or databases, in the cloud 1000. As mentioned above, controller 210 is capable of and may be operable to perform any methods and associated method steps as disclosed herein. Additionally, performance of such methods and method steps may also be distributed, e.g., one or more steps of a method may be performed by the primary household appliance (e.g., controller thereof), while one or more other steps of the same method may be performed by another device, such as a remote computing device (e.g., the cloud) and/or one or more secondary household appliances.

The primary household appliance 10 may also be in wireless communication with one or more additional, secondary household appliances 11, e.g., via a direct wireless connection and/or with data and other communications relayed between the primary household appliance 10 and the one or more secondary household appliances 11 via a local network, such as a residential wireless network or other wireless local area network (“WLAN”).

The primary household appliance 10 may be in communication with the secondary household appliances 11 through various possible communication connections and interfaces. The primary household appliance 10 and the secondary household appliances 11 may be matched in wireless communication, e.g., connected to the same wireless network. The primary household appliance 10 may communicate with the secondary household appliances 11 via short-range radio such as BLUETOOTH® or any other suitable wireless network having a layer protocol architecture. As used herein, “short-range” may include ranges less than about ten meters and up to about one hundred meters. For example, the wireless network may be adapted for short-wavelength ultra-high frequency (UHF) communications in a band between 2.4 GHz and 2.485 GHz (e.g., according to the IEEE 802.15.1 standard). In particular, BLUETOOTH® Low Energy, e.g., BLUETOOTH® Version 4.0 or higher, may advantageously provide short-range wireless communication between the primary household appliance 10 and the secondary household appliances 11. For example, BLUETOOTH® Low Energy may advantageously minimize the power consumed by the exemplary methods and devices described herein due to the low power networking protocol of BLUETOOTH® Low Energy.

In some embodiments, the performance of exemplary methods and associated method steps may be distributed, e.g., performed in part by the controller 210 of the primary and/or secondary household appliances 10 and 11, and in part by one or more remote computing devices in the cloud 1000. For example, data, which may include identifying information for the household appliances 10 and 11 and version information, e.g., firmware version information, such as a version number or revision date, etc., may be transmitted from the primary and/or secondary household appliances 10 and 11, and in particular from the primary household appliance 10 to the cloud 1000. The data may be analyzed or processed, e.g., in the cloud 1000 in embodiments which include distributed computing as described above.

As mentioned above, advantages of the present methods include (but are not limited to) a more streamlined user experience for managing updates across multiple household appliances. For example, the present methods may provide a more convenient way to manage cloud connectivity and/or software updates for a secondary household appliance using a primary household appliance, e.g., a connected household appliance with a high-end user interface. The secondary household appliance may be, e.g., a new household appliance, a household appliance that is not connected to the cloud, or a household appliance with a low-end user interface, etc.

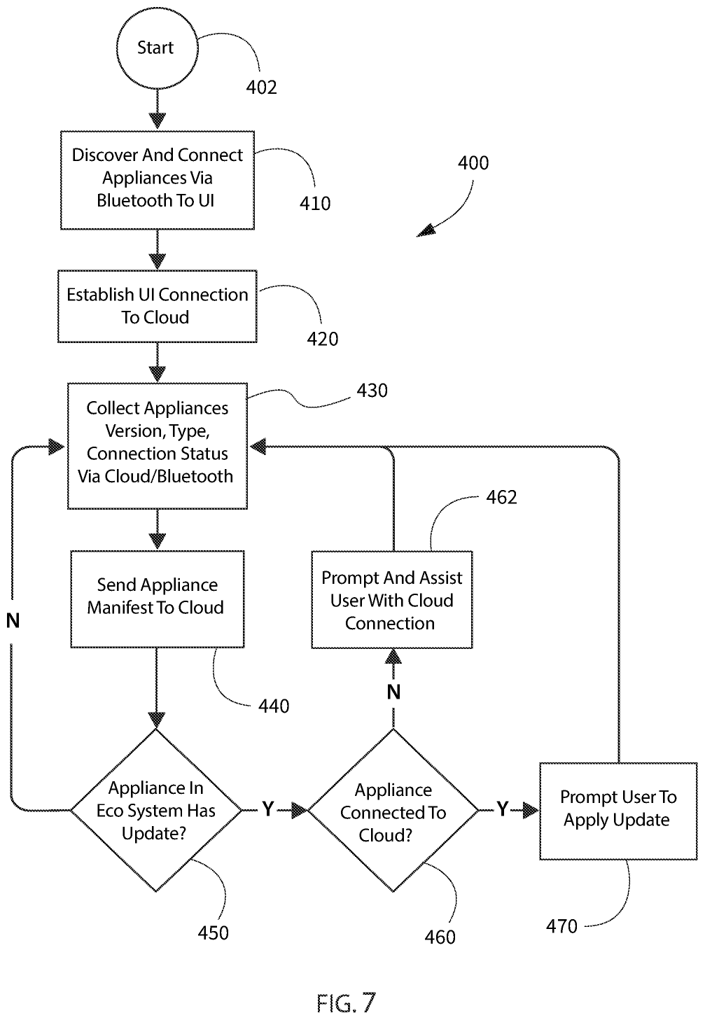

One example of such a method or operating a group of household appliances is method 400 illustrated in FIG. 7. As may be seen in FIG. 7, method 400 begins at a start or initiation step 402. The method 400 may then proceed to a step 410 of discovering and connecting household appliances, e.g., one or more secondary appliances, to a user interface (“UI”), such as a high-end UI of a primary household appliance, e.g., as described above. The connection between the primary household appliance, and the high-end UI thereof, at step 410 may be a short-range or local connection (as distinct from a long-rage or remote connection, such as over the internet), e.g., a short-range radio connection such as BLUETOOTH®, etc., as described above. Method 400 may further include a step 420 of connecting the primary household appliance, e.g., the household appliance having a high-end UI or one of the household appliances having a high-end UI, to one or more remote computing devices, e.g., in the cloud, as described above.

Method 400 may also include developing or generating a manifest of the group of household appliances, e.g., including the primary household appliance and the one or more secondary appliances, and the group of household appliances may be referred to collectively as an eco system. For example, method 400 may include a step 430 of collecting information about each household appliance of the group of household appliances and populating the manifest with such information. The information in the manifest may include an identifier for each household appliance, such as an appliance type, name, and/or model number, etc., version information, such as software version or firmware version information, e.g., a version number and/or revision date or update date, and connection status such as whether the household appliance, and in particular each secondary household appliance, is connected to the one or more remote computing devices, e.g., the cloud.

The information for the manifest may be collected by the primary household appliance, e.g., over the short-range connection described above, and/or by the remote computing device, e.g., when the or each secondary household appliance connects to the remote computing device. A single manifest which synthesizes information from both of the foregoing sources may be generated, e.g., by the primary household appliance. The manifest may then be transmitted to the remote computing device, for example as illustrated at step 440 in FIG. 7, such as from the primary household appliance to the remote computing device.

Once the manifest is generated and received by the remote computing device, the remote computing device may then determine whether each household appliance of the group of household appliances has an update available (e.g., an update for the firmware or control software stored in a memory of a controller of each household appliance), e.g., as illustrated at 450 in FIG. 7. In particular, method 400 may include determining whether an update is available for a household appliance, e.g., one of the secondary household appliances, regardless of whether that household appliance is connected to the cloud.

Thus, for example, the method 400 may include a step 460 of determining whether the household appliance, e.g., one or more household appliances for which an available update was identified at step 450, is connected to the cloud.

When the household appliance having an available update is connected to the cloud, the method 400 may download the update and then proceed directly to step 470 of prompting a user to apply the downloaded update. For example, the prompt to apply the update to a secondary household appliance may be provided on the primary household appliance, e.g., on the high-end UI thereof.

When the household appliance having an available update is not connected to the cloud, the method 400 may proceed from step 460 to a step 462 of prompting and assisting the user with connecting the household appliance having an available update to the cloud. For example, a prompt may be provided on the high-end UI of the primary household appliance informing the user that an update is available for the secondary household appliance and asking whether the user wishes to connect the secondary household appliance to the cloud. After receiving an affirmative response to such prompt, instructions and guidance may be provided, e.g., on the high-end UI of the primary household appliance, to direct the user through the steps to connect the secondary household appliance to the cloud.

Once the household appliance for which an available update was identified is connected to the cloud, e.g., after step 462, the method 400 may return to step 430 and update the manifest. For example, the manifest may be updated with information about the newly-connected secondary household that is directly transmitted to the cloud, e.g., from the secondary appliance over the internet as opposed to collected by the primary appliance via BLUETOOTH® (or other short-range communication) and then transmitted to the cloud from the primary household appliance. As illustrated in FIG. 7, method 400 may then continue through the successive steps described above to complete the updating process for the secondary household appliance.

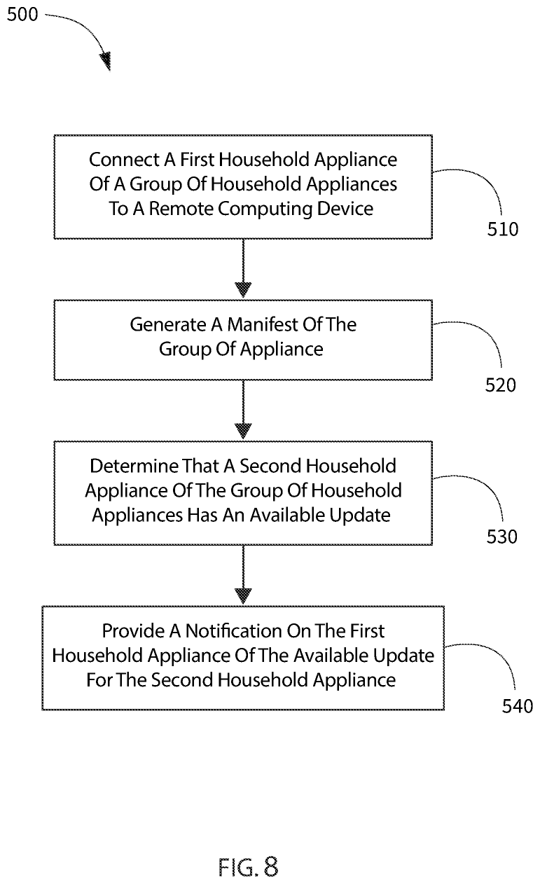

Another exemplary method 500 of operating a group of household appliances according to one or more embodiments of the present disclosure is illustrated in FIG. 8. As illustrated in FIG. 8, such methods may include a step 510 of connecting to a remote computing device, such as connecting to one or more remote computing devices, e.g., in the cloud, as discussed above. The step 510 may be performed by a primary household appliance of the group of household appliances. Thus, in various embodiments, less than all of the group of household appliances may be connected to the cloud at least at the beginning of the method, such as the primary household appliance may be the only household appliance of the group of household appliances that is connected to the cloud, or may be one of a subset of the group of household appliances that is connected to the cloud.

Method 500 may further include a step 520 of generating a manifest of the group of appliances. The manifest may be generated by the primary household appliance, by the remote computing device, or both. For example, generating the manifest may include identifying one or more household appliances of the group of household appliances by the primary household appliance, such as collecting information from the secondary household appliances by the primary household appliance using short-range communication. As another example, generating the manifest may also or instead include identifying one or more household appliances of the group of household appliances by the remote computing device when the one or more household appliances of the group of household appliances connect to the remote computing device. In such embodiments, the secondary household appliances may be connected to the remote computing device, e.g., cloud, at the beginning of method 500, or may no longer be connected to the remote computing device and method 500 may include steps to re-connect the secondary household appliance. For example, method 500 may include identifying available updates in the cloud for household appliances that once were but are not at the time of identifying the updates connected to the cloud.

Method 500 may also include a step 530 of determining that a secondary household appliance of the group of household appliances has an available update. For example, such determination may be made by the remote computing device. Also by way of example, the available updates may be detected using the manifest, e.g., by comparing information in the manifest to current version information for each household appliance included in the manifest. In some embodiments, the information in the manifest may include an identifier for each household appliance of the group of household appliances and version information for each household appliance of the group of household appliances.

In embodiments where the manifest is generated at least partially by the primary household appliance, method 500 may include transmitting the manifest from the primary household appliance to the remote computing device. Such embodiments include embodiments where the manifest is generated solely by the primary household appliance and embodiments wherein the manifest is synthesized by the primary household appliance from data collected both in the cloud and by the primary household appliance. Further, in such embodiments, the step of determining that the secondary household appliance of the group of household appliances has an available update may be performed by the remote computing device using the manifest, such as by looking up the information on the manifest, e.g., version information, in a remote database to compare to the latest version of, e.g., firmware, available for the one or more secondary appliances.

As mentioned above, method 500 may include steps to connect or re-connect one or more secondary household appliances to the cloud. For example, method 500 may include determining that the secondary household appliance is not connected to the remote computing device, such as the secondary appliance has never been connected to the remote computing device or was connected but is no longer. Such embodiments may also include providing instructions for connecting the secondary household appliance to the remote computing device, such as providing the instructions via the primary household appliance, e.g., the high-end user interface thereof.

Once the household appliance for which the available update has been identified is connected to the remote computing device, e.g., the cloud, the update may be downloaded and then applied. For example, when the household appliance for which the available update has been identified is already connected to the remote computing device or is connected after providing notices and/or guidance on the primary household appliance, the update may be downloaded and applied. In some embodiments, for example, method 500 may include downloading the available update for the secondary household appliance to the secondary household appliance, and then, after downloading the update, providing a prompt to accept the available update for the secondary household appliance. The prompt to accept the available update may be provided on the primary household appliance in some embodiments. When the update is accepted, the previously-downloaded update may then be installed onto the secondary household appliance.

Method 500 may further include a step 540 of providing a notification of the available update for the secondary household appliance. The notification of the available update for the secondary household appliance may be provided on the primary household appliance. For example, the primary household appliance may include a context-sensitive user interface or other high-end interface, as described above, and the notification of the available update for the secondary household appliance may be provided on the context-sensitive user interface of the primary household appliance.

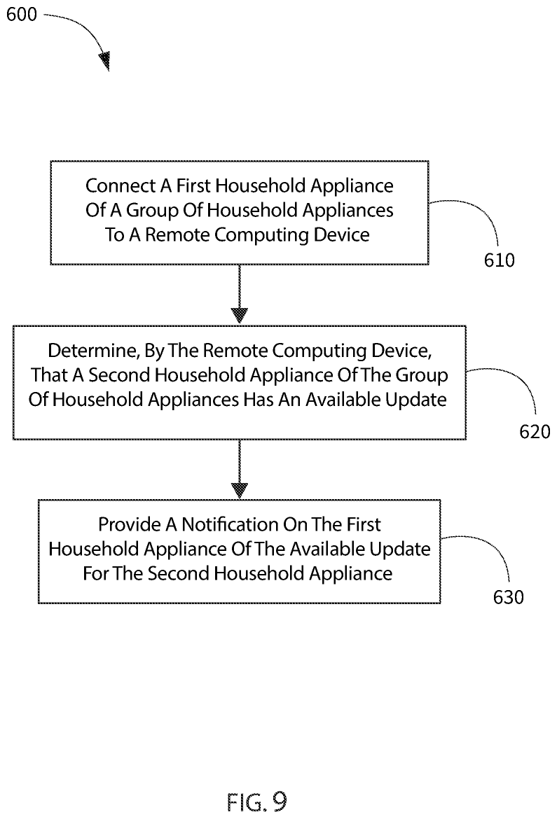

Exemplary methods according to the present disclosure also include method 600 of operating a group of household appliances as illustrated in FIG. 9. In some embodiments, method 600 may include a step 610 of connecting to a remote computing device, such as connecting to one or more remote computing devices, e.g., in the cloud, as discussed above. The step 610 may be performed by a primary household appliance of the group of household appliances. Thus, in various embodiments, less than all of the group of household appliances may be connected to the cloud at least at the beginning of the method, such as the primary household appliance may be the only household appliance of the group of household appliances that is connected to the cloud, or may be one of a subset of the group of household appliances that is connected to the cloud.

Method 600 may further include a step 620 of determining that a secondary household appliance of the group of household appliances has an available update. The determining step 620 may be performed, for example, by the remote computing device. Also by way of example, the available updates may be detected using a manifest of the group of appliances, e.g., by comparing information in the manifest to current version information for each household appliance included in the manifest. In some embodiments, the information in the manifest may include an identifier for each household appliance of the group of household appliances and version information for each household appliance of the group of household appliances.

Method 600 may further include a step 630 of providing a notification of the available update for the secondary household appliance. The notification of the available update for the secondary household appliance may be provided on the primary household appliance. For example, the primary household appliance may include a context-sensitive user interface or other high-end interface, as described above, and the notification of the available update for the secondary household appliance may be provided on the context-sensitive user interface of the primary household appliance.

Method 600 may also include generating a manifest of the group of appliances. The manifest may be generated by the primary household appliance, by the remote computing device, or both. For example, generating the manifest may include identifying one or more household appliances of the group of household appliances by the primary household appliance, such as collecting information from the secondary household appliances by the primary household appliance using short-range communication. As another example, generating the manifest may also or instead include identifying one or more household appliances of the group of household appliances by the remote computing device when the one or more household appliances of the group of household appliances connect to the remote computing device. In such embodiments, the secondary household appliances may be connected to the remote computing device, e.g., cloud, at the beginning of method 600, or may no longer be connected to the remote computing device and method 600 may include steps to re-connect the secondary household appliance. For example, method 600 may include identifying available updates in the cloud for household appliances that once were but are not at the time of identifying the updates connected to the cloud.

In embodiments where the manifest is generated at least partially by the primary household appliance, method 600 may include transmitting the manifest from the primary household appliance to the remote computing device. Such embodiments include embodiments where the manifest is generated solely by the primary household appliance and embodiments wherein the manifest is synthesized by the primary household appliance from data collected both in the cloud and by the primary household appliance. Further, in such embodiments, the step of determining that the secondary household appliance of the group of household appliances has an available update may be performed by the remote computing device using the manifest, such as by looking up the information on the manifest, e.g., version information, in a remote database to compare to the latest version of, e.g., firmware, available for the one or more secondary appliances.

As mentioned above, method 600 may include steps to connect or re-connect one or more secondary household appliances to the cloud. For example, method 600 may include determining that the secondary household appliance is not connected to the remote computing device, such as the secondary appliance has never been connected to the remote computing device or was connected but is no longer. Such embodiments may also include providing instructions for connecting the secondary household appliance to the remote computing device, such as providing instructions via the primary household appliance, e.g., the high-end user interface thereof.

Once the household appliance for which the available update has been identified is connected to the remote computing device, e.g., the cloud, the update may be downloaded and then applied. For example, when the household appliance for which the available update has been identified is already connected to the remote computing device or is connected after providing notices and/or guidance on the primary household appliance, the update may be downloaded and applied. In some embodiments, for example, method 600 may include downloading the available update for the secondary household appliance to the secondary household appliance, and then, after downloading the update, providing a prompt to accept the available update for the secondary household appliance. The prompt to accept the available update may be provided on the primary household appliance in some embodiments. When the update is accepted, the previously-downloaded update may then be installed onto the secondary household appliance.

Methods and systems according to the present disclosure provide numerous advantages and improvements to technological processes such as connecting household appliances having limited user interfaces to networks such as the internet and/or the cloud, as well as updating household appliances. For example, household appliances having relatively simple, low-end user interfaces often have a low adoption rate for connectivity features and potential updates to the household appliances which may be provided using such connectivity. Accordingly, the present disclosure may be advantageous in that one household appliance which is already connected and/or with which the user more frequently interacts may provide an improved or more accessible user experience or user interface for connecting and updating another household appliance, e.g., another household appliance with a less sophisticated user interface

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a group of household appliances, the method comprising:
connecting, by a primary household appliance of the group of household appliances, to a remote computing device;
generating a manifest of the group of appliances;
determining that a secondary household appliance of the group of household appliances has an available update; and
providing, on the primary household appliance, a notification of the available update for the secondary household appliance.

2. The method of claim 1, further comprising determining that the secondary household appliance is not connected to the remote computing device, and providing, via the primary household appliance, instructions for connecting the secondary household appliance to the remote computing device.

3. The method of claim 1, further comprising providing a prompt on the primary household appliance to accept the available update for the secondary household appliance.

4. The method of claim 3, further comprising, prior to providing the prompt on the primary household appliance, downloading the available update for the secondary household appliance to the secondary household appliance.

5. The method of claim 1, wherein the primary household appliance comprises a context-sensitive user interface and wherein the notification of the available update for the secondary household appliance is provided on the context-sensitive user interface of the primary household appliance.

6. The method of claim 1, wherein generating the manifest comprises identifying one or more household appliances of the group of household appliances by the primary household appliance.

7. The method of claim 1, wherein generating the manifest comprises identifying one or more household appliances of the group of household appliances by the remote computing device when the one or more household appliances of the group of household appliances connect to the remote computing device.

8. The method of claim 1, further comprising transmitting the manifest from the primary household appliance to the remote computing device, wherein the step of determining that the secondary household appliance of the group of household appliances has an available update is performed by the remote computing device using the manifest.

9. The method of claim 1, wherein the manifest of the group of household appliances includes an identifier for each household appliance of the group of household appliances and version information for each household appliance of the group of household appliances.

10. A method of operating a group of household appliances, the method comprising:
connecting, by a primary household appliance of the group of household appliances, to a remote computing device;
determining, by the remote computing device, that a secondary household appliance of the group of household appliances has an available update; and
providing, on the primary household appliance, a notification of the available update for the secondary household appliance.

11. The method of claim 10, further comprising determining that the secondary household appliance is not connected to the remote computing device, and providing, via the primary household appliance, instructions for connecting the secondary household appliance to the remote computing device.

12. The method of claim 10, further comprising providing a prompt on the primary household appliance to accept the available update for the secondary household appliance.

13. The method of claim 12, further comprising, prior to providing the prompt on the primary household appliance, downloading the available update for the secondary household appliance to the secondary household appliance.

14. The method of claim 10, wherein the primary household appliance comprises a context-sensitive user interface and wherein the notification of the available update for the secondary household appliance is provided on the context-sensitive user interface of the primary household appliance.

15. The method of claim 10, further comprising generating a manifest of the group of household appliances.

16. The method of claim 15, wherein generating the manifest comprises identifying one or more household appliances of the group of household appliances by the primary household appliance.

17. The method of claim 15, wherein generating the manifest comprises identifying one or more household appliances of the group of household appliances by the remote computing device when the one or more household appliances of the group of household appliances connect to the remote computing device.

18. The method of claim 15, further comprising transmitting the manifest from the primary household appliance to the remote computing device, wherein the step of determining that the secondary household appliance of the group of household appliances has an available update is performed by the remote computing device using the manifest.

19. The method of claim 15, wherein the manifest of the group of household appliances includes an identifier for each household appliance of the group of household appliances and version information for each household appliance of the group of household appliances.
